(19) United States
(12) Patent Application Publication
(10) Pub. No.: US 2023/0121833 A1
(43) Pub. Date: Apr. 20, 2023

(54) UNMANNED AERIAL VEHICLE

(71) Applicant: NIPPON TELEGRAPH AND TELEPHONE CORPORATION, Tokyo (JP)

(72) Inventors: Kazuaki WATANABE, Tokyo (JP); Yujin HAMANO, Tokyo (JP); Daisuke UCHIBORI, Tokyo (JP); Masafumi NAKAGAWA, Tokyo (JP); Atsushi ARATAKE, Tokyo (JP)

(73) Assignee: NIPPON TELEGRAPH AND TELEPHONE CORPORATION, Tokyo (JP)

(21) Appl. No.: 17/913,209

(22) PCT Filed: Mar. 25, 2020
(86) PCT No.: PCT/JP2020/013422

§ 371 Date: Sep. 21, 2022

(51) Int. Cl. B64C 39/02; B64C 25/36; B64U 60/10; B64U 50/13; B64C 25/54; B64U 20/87

(52) U.S. Cl. CPC B64C 39/024; B64C 25/36; B64U 60/10; B64U 50/13; B64C 25/54; B64U 20/87; B64U 2101/30

(57) ABSTRACT

An unmanned aircraft (100) according to the present disclosure is equipped with a flight propeller (2) and includes a main body (1), a locomotion unit having an aquatic locomotion mechanism and a terrestrial locomotion mechanism independent of the flight propeller, and a connector that connects the main body and the locomotion mechanisms.

### TECHNICAL FIELD

The present disclosure relates to an unmanned aircraft.

### BACKGROUND ART

A method of inspecting communication manholes using an autopilot unmanned aircraft is now under study. In this method, an unmanned aircraft enters a manhole, and a camera mounted on the unmanned aircraft automatically takes pictures of the condition of upper concrete slabs of the manhole structure body, which is one of the items to be checked for communication manholes (see, for example, NPL 1).

### CITATION LIST

### Non Patent Literature

[NPL 1] “Development of automatic inspection technology for communication manholes using drone”, Daisuke Uchibori and 4 others, Proceedings of The 19th Symposium on Construction Robotics, O2-O2, October 2019.

### SUMMARY OF THE INVENTION

### Technical Problem

Since the interior space of a manhole is too confined for the conventional unmanned aircraft to fly stably, it was necessary to land the unmanned aircraft on a floor surface or the like when taking pictures of the interior of a manhole. Sometimes there is ground water, rain water, or the like that has accumulated in the manhole, and the conventional unmanned aircraft could land on the surface of accumulated water. The unmanned aircraft further needed to be able to move around inside the manhole for the shooting after having landed on the floor and the like or water surface. Another requirement is to stay afloat on the water. Accordingly it has been desired to develop an unmanned aircraft equipped with terrestrial and aquatic locomotion capabilities independent of flight propellers.

An object of the present disclosure in view of such circumstances is to provide an unmanned aircraft having terrestrial and aquatic locomotion capabilities independent of flight propellers.

### Means for Solving the Problem

According to one embodiment, there is provided an unmanned aircraft equipped with a flight propeller and including a main body, a locomotion unit having an aquatic locomotion mechanism and a terrestrial locomotion mechanism independent of the flight propeller, and a connector that connects the main body and the locomotion mechanisms.

### Effects of the Invention

The present disclosure can provide an unmanned aircraft having terrestrial and aquatic locomotion capabilities independent of flight propellers.

### BRIEF DESCRIPTION OF DRAWINGS

FIG. 1A is a diagram illustrating a state of an unmanned aircraft according to Embodiment 1 when moving on land.

FIG. 1B is a diagram illustrating a state of the unmanned aircraft according to Embodiment 1 when moving on water.

FIG. 2 is a side view illustrating one example of a structure of a manhole.

FIG. 3A is a diagram illustrating a wheel connector that enables the unmanned aircraft according to Embodiment 1 to change directions.

FIG. 3B is a diagram illustrating the wheel connector that enables the unmanned aircraft according to Embodiment 1 to change directions.

FIG. 3C is a diagram illustrating the wheel connector that enables the unmanned aircraft according to Embodiment 1 to change directions.

FIG. 4A is a diagram illustrating a state of the unmanned aircraft according to Embodiment 1 when moving on water by water wheels.

FIG. 4B is a diagram illustrating a state of the unmanned aircraft according to Embodiment 1 when moving on water by water wheels.

FIG. 5A is a diagram illustrating a state of the unmanned aircraft according to Embodiment 1 when changing directions by water wheels.

FIG. 5B is a diagram illustrating a state of the unmanned aircraft according to Embodiment 1 when changing directions by water wheels.

FIG. 6A is a diagram illustrating a state of an unmanned aircraft according to Embodiment 2 when moving on land.

FIG. 6B is a diagram illustrating a state of the unmanned aircraft according to Embodiment 2 when moving on water.

FIG. 7A is a diagram illustrating a screw and a screw connector that enable the unmanned aircraft according to Embodiment 2 to change directions.

FIG. 7B is a diagram illustrating the screw and the screw connector that enable the unmanned aircraft according to Embodiment 2 to change directions.

FIG. 8A is a diagram illustrating a state of an unmanned aircraft according to Embodiment 3 when moving on land.

FIG. 8B is a diagram illustrating a state of the unmanned aircraft according to Embodiment 3 when moving on water.

FIG. 9A is a diagram illustrating a configuration of an amphibious wheel of the unmanned aircraft according to Embodiment 3.

FIG. 9B is a diagram illustrating the configuration of the amphibious wheel of the unmanned aircraft according to Embodiment 3.

FIG. 9C is a diagram illustrating a configuration of an amphibious wheel of the unmanned aircraft according to Embodiment 3.

FIG. 9D is a diagram illustrating the configuration of the amphibious wheel of the unmanned aircraft according to Embodiment 3.

FIG. 10A is a diagram illustrating a state of an unmanned aircraft according to Embodiment 4 when moving on land.

FIG. 10B is a diagram illustrating a state of the unmanned aircraft according to Embodiment 4 when moving on water.

FIG. 11A is a diagram illustrating a state of the unmanned aircraft according to Embodiment 4 equipped with one Archimedean screw when moving on land.

FIG. 11B is a diagram illustrating a state of the unmanned aircraft according to Embodiment 4 equipped with one Archimedean screw when moving on water.

FIG. 12A is a diagram illustrating a state of the unmanned aircraft according to Embodiment 4 equipped with two Archimedean screws when moving on land.

FIG. 12B is a diagram illustrating a state of the unmanned aircraft according to Embodiment 4 equipped with two Archimedean screws when moving on water.

FIG. 13A is a diagram illustrating an extendable connector that makes changeable the distance in the height direction of the unmanned aircraft according to Embodiment 5.

FIG. 13B is a diagram illustrating the extendable connector that makes changeable the distance in the height direction of the unmanned aircraft according to Embodiment 5.

FIG. 14A is a diagram illustrating a state of an unmanned aircraft according to Embodiment 6 given buoyancy by a float when moving on water.

FIG. 14B is a diagram illustrating a state of the unmanned aircraft according to Embodiment 6 given buoyancy by amphibious wheels when moving on water.

### DESCRIPTION OF EMBODIMENTS

Hereinafter modes for carrying out the present disclosure will be described with reference to the drawings. In the following description, terms “upper”, “lower”, and “vertical” shall refer to directions parallel to the Z axis of the coordinate axes illustrated in the drawings. The term “horizontal” shall refer to a direction parallel to the XY plane of the coordinate axes illustrated in the drawings. While the unmanned aircraft 100 is assumed to become substantially horizontal when landed, the horizontal direction of the unmanned aircraft 100 referred to herein does not necessarily mean that the aircraft will always be substantially horizontal in flight or when landed anywhere including on water. It should be noted that the unmanned aircraft 100 can go out of substantially horizontal depending on its posture or the like during operation.

### Embodiment 1

Next, the configuration of the unmanned aircraft 100 according to Embodiment 1 of the present disclosure will be described in detail.

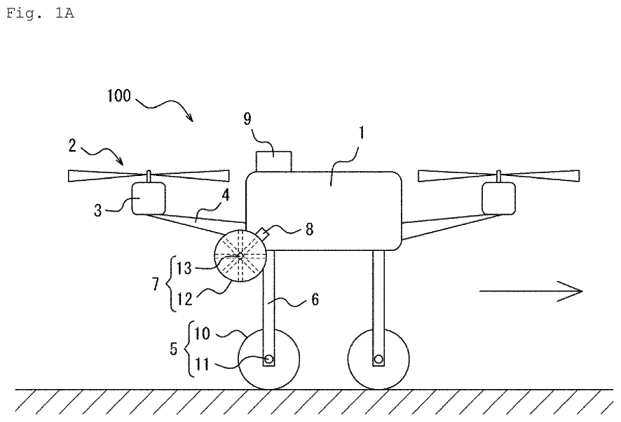

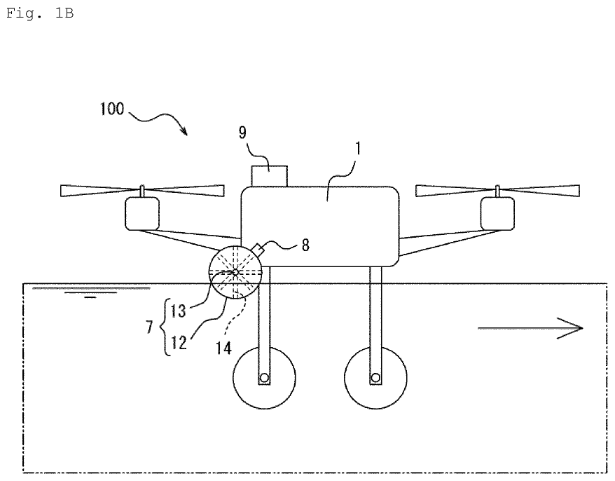

As illustrated in FIG. 1A and FIG. 1B, the unmanned aircraft 100 includes a main body 1, flight propellers 2, motors 3, arms 4, a control unit (not shown), a terrestrial locomotion unit (locomotion unit) 5, wheel connectors (connector) 6, an aquatic locomotion unit (locomotion unit) 7, water wheel connectors (connector) 8, and a camera 9. The terrestrial locomotion unit 5 includes wheels (terrestrial locomotion mechanism) 10 and wheel shafts 11. The aquatic locomotion unit 7 includes water wheels (aquatic locomotion mechanism) 12 and water wheel shafts 13.

The main body 1 has a quadrate shape in plan view and covered by a plate material of, for example, CFRP (Carbon Fiber Reinforced Plastics). The flight propellers 2 each include a plurality of blades (not shown). The flight propellers 2 are each driven to rotate by their respective motors 3 and generate lift. The arms 4 are rod-like support members which extend substantially horizontally and support the flight propellers 2 such as to be rotatable.

The control unit is a small computer including, for example, Raspberry Pi (Registered Trademark), which controls various parts of the unmanned aircraft 100 as described below in detail.

A configuration of a manhole 200 is now briefly explained.

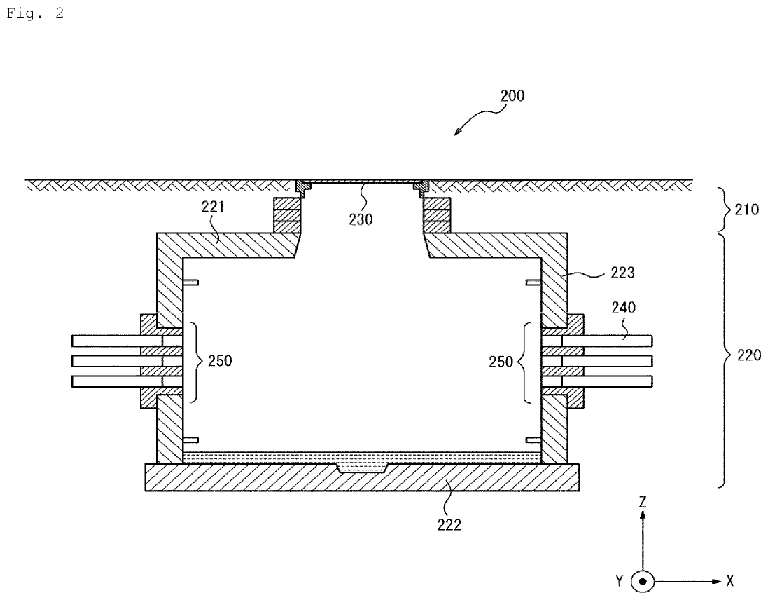

As illustrated in FIG. 2, the manhole 200 is a standard communication manhole. The manhole 200 includes a neck 210, a structure body 220, an iron lid 230, pipes 240, and ducts 250. The structure body 220 includes an upper slab 221, a lower slab 222, and side walls 223. The interior of the manhole 200 is encircled by the wall surfaces of the side walls 223, the ceiling surface of the upper slab 221, the floor surface of the lower slab 222 (or water surface of accumulated water 300) and the like. Through holes are formed in the side walls 223 for connection with a plurality of pipes 240, where the ducts 250 are installed. The iron lid 230 is substantially columnar and fits in a manhole opening that allows access to the manhole 200. The manhole opening is formed at the boundary between the ground level and the underground. Communication cables and the like are laid in the plurality of pipes 240.

Referring back to FIG. 1A, the camera 9 is provided on top of the main body 1. The unmanned aircraft 100 enters the manhole 200 through the manhole opening and moves around inside the manhole 200 for investigation, for example. In this case, the camera 9 takes pictures of the ceiling surface of the upper slab 221, or the wall surfaces or the like of the side walls 223 by the control through the control unit. The camera 9 may for example be provided on the side or at the bottom of the main body 1 to take pictures of the floor surface of the lower slab 222 (or water surface of accumulated water) in addition to the ceiling surface of the upper slab 221 and the wall surfaces of the side walls 223.

The wheel connector 6 is a rod-like or plate-like member. The wheel connector 6 extends downward from a bottom surface of the main body 1 of the unmanned aircraft 100 at one end, and is connected to the wheel 10 via the wheel shaft 11 at the other end. The wheel 10 is a rotating body that enables the unmanned aircraft 100 to move on land, and is rotatable around the wheel shaft 11 as its axis.

In this embodiment, one wheel 10 is connected to each one of the wheel connectors 6. The unmanned aircraft 100 may include a total of three wheels 10. For clear view, FIG. 1A shows two wheels 10. The number of wheels 10 is not limited to three. As long as the wheels allow the unmanned aircraft 100 to move on land while supporting the main body 1 on land via the wheel connectors 6, there may be two or less, or four or more. The wheels 10 are provided at a lower position than the water wheels 12, i.e., at such a height from the floor surface that, when the wheels 10 are in contact with the floor surface, the water wheels 12 do not tough the floor surface. The wheel 10 may be provided with an actuator (not shown) and may be driven based on a control signal from the control unit.

The operation of the unmanned aircraft 100 on land according to Embodiment 1 will be described in detail below. As illustrated in FIG. 1A, the unmanned aircraft 100 moves on land in the direction of the arrow (moving direction) when the wheels 10 are driven. The wheels 10 may be driven by actuators (not shown) based on a control signal from the control unit.

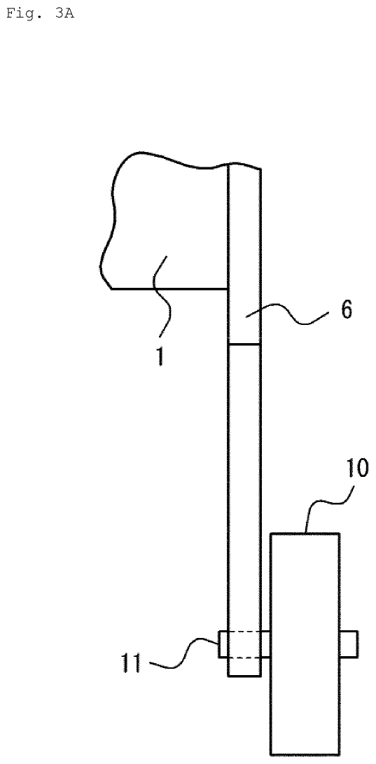

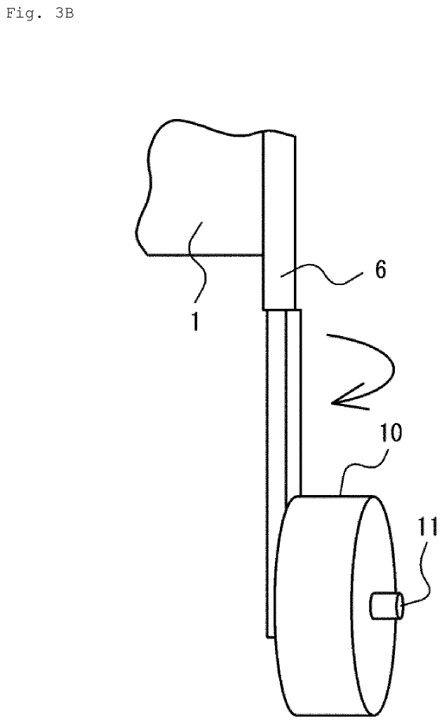

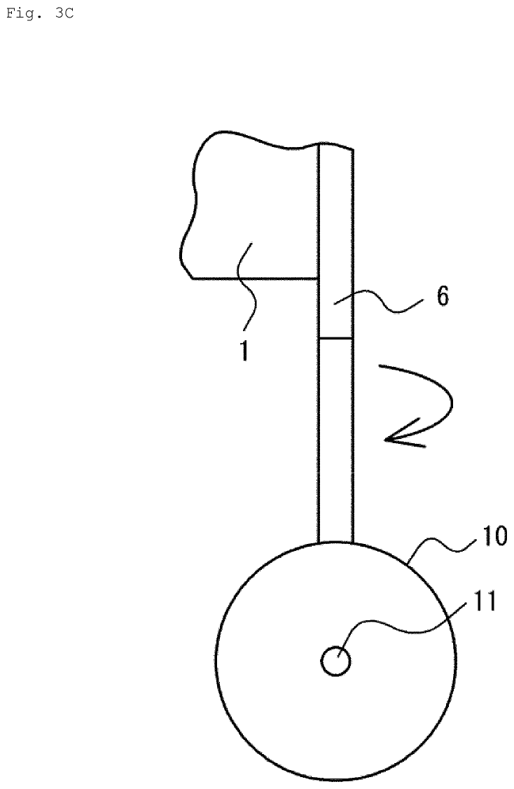

The terrestrial locomotion unit 5 may be configured to be able to change directions. In the case where the unmanned aircraft 100 is fitted with three wheels 10, a direction change is possible if at least one of them is capable of changing directions. In the case where the unmanned aircraft 100 is fitted with four wheels 10, at least two of them may be designed capable of changing directions. Specifically, as illustrated in FIG. 3A, FIG. 3B, and FIG. 3C, the wheel connector 6 is divided in two substantially in the middle, and the two divided parts of the wheel connector 6 are rotatably connected via a bearing (not shown). This allows the wheel 10 connected to the wheel connector 6 via the wheel shaft 11 to turn. The wheels 10 may be turned by actuators (not shown) provided to the wheel connectors 6 based on a control signal from the control unit. This way the unmanned aircraft 100 can freely change directions when moving on land.

Referring back to FIG. 1B, the aquatic locomotion unit 7 includes water wheels (aquatic locomotion mechanism) 12 and water wheel shafts 13. The water wheel connector 8 is a rod-like or plate-like member. The water wheel connector 8 extends from a lower part of the main body 1 of the unmanned aircraft 100 at one end diagonally downward oppositely from the direction of the arrow (moving direction), and is connected to the water wheel 12 via the water wheel shaft 13 at the other end. The water wheel 12 is a rotating body that enables the unmanned aircraft 100 to move on water, and is rotatable around the water wheel shaft 13 as its axis. The water wheel 12 has radially oriented paddles 14.

In this embodiment, one water wheel 12 is connected to each one of water wheel connectors 8. A total of two water wheels 12 may be provided, one each on both sides of the main body 1, for example on the left and right side of the main body 1. For clear view, FIG. 1B shows one water wheel 12. The number of water wheels 12 is not limited to two. As long as the water wheels allow the unmanned aircraft 100 to move on water while supporting the main body 1 on water via the water wheel connectors 8, there may be one or less, or three or more. The water wheels 12 are provided at a higher position than the wheels 10. The water wheels 12 are positioned such as to be half submerged in water when the unmanned aircraft 100 moves on water. The water wheel 12 may be provided with an actuator (not shown) and may be driven based on a control signal from the control unit.

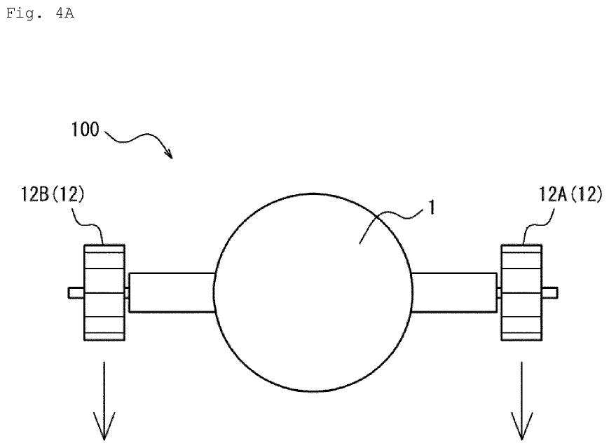

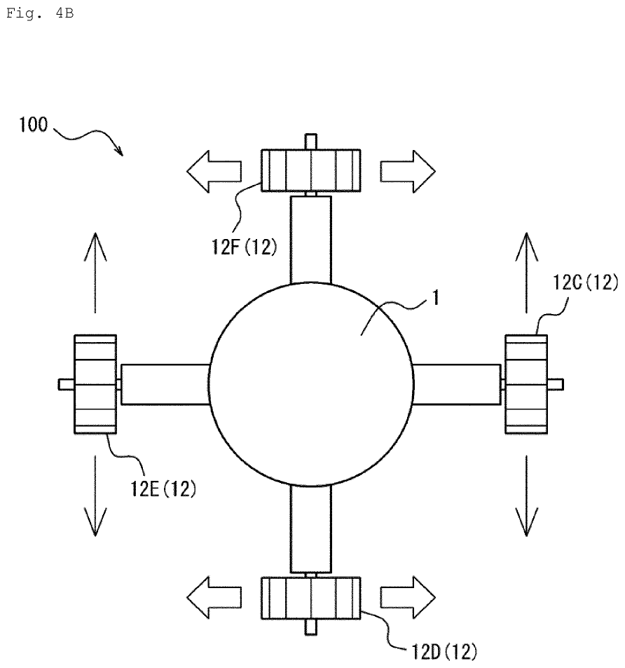

The operation of the unmanned aircraft 100 on water according to Embodiment 1 will be described in detail below. FIG. 4A and FIG. 4B are plan views from above of the unmanned aircraft 100 having water wheels 12, illustrating the unmanned aircraft 100 moving in one direction on water.

The unmanned aircraft 100 having two water wheels 12 will be described with reference to FIG. 4A. The water wheel 12A and water wheel 12B are provided on both sides of the main body 1. When actuators (not shown) rotate the water wheel 12A and water wheel 12B in the direction of arrows (moving direction) based on a control signal from the control unit, the water wheel 12A and water wheel 12B pump water in the opposite direction from the direction of arrows at high pressure. The pressure of this pumped water moves or propels the unmanned aircraft 100 forward on water.

To move the unmanned aircraft 100 in the opposite direction from the moving direction described above, i.e., to back, the water wheel 12A and water wheel 12B are rotated in the opposite direction from the direction of arrows (moving direction) by actuators (not shown) based on a control signal from the control unit. The water wheel 12A and water wheel 12B then pump water in the direction of arrows at high pressure, and the pressure of this pumped water moves or propels the unmanned aircraft 100 backward on water in the opposite direction from the direction of arrows.

FIG. 4B illustrates an unmanned aircraft 100 having four water wheels 12. Four water wheels 12C, 12D, 12E, and 12F are each provided on each of the four sides of the main body 1 of the unmanned aircraft 100. The unmanned aircraft 100 having four water wheels 12 can similarly move forward and backward as described above by rotating the water wheel 12C and water wheel 12E on both sides of the main body 1 by actuators (not shown) based on a control signal from the control unit. The unmanned aircraft 100 having four water wheels 12, in particular, can move in the directions of white arrows (left and right directions) by rotating the water wheel 12D and water wheel 12F, in addition to the movement in the front to back direction described above.

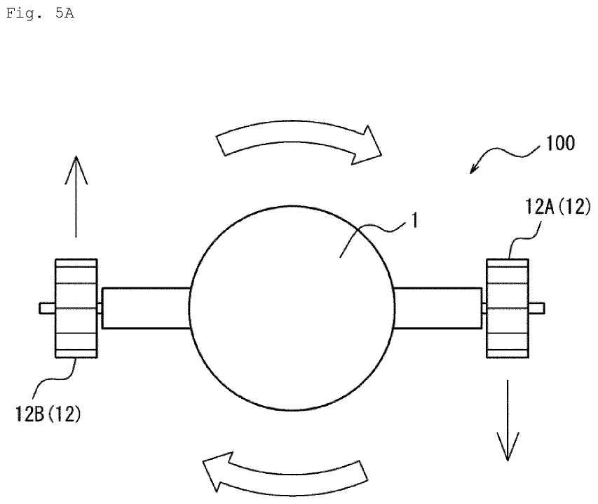

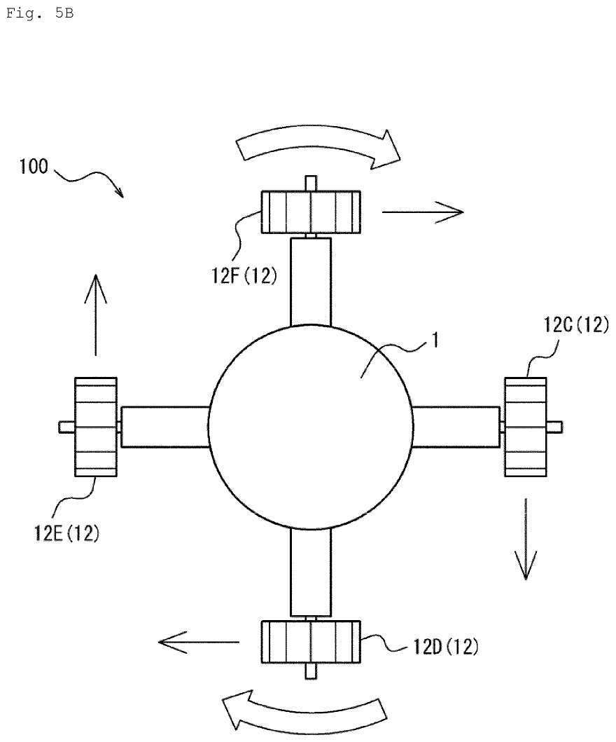

The aquatic locomotion unit 7 may be configured to be able to change directions. In the case where the unmanned aircraft 100 is fitted with two water wheels 12, a direction change can be done by rotating the water wheel 12A and water wheel 12B in different directions as shown in FIG. 5A. Specifically, rotating the water wheel 12A and water wheel 12B each in the directions of black arrows, i.e., in opposite directions, for example, the pressure of the pumped water causes the unmanned aircraft 100 to rotate in the direction of white arrows (clockwise) on water. Reversing the respective rotating directions of the water wheel 12A and water wheel 12B causes the unmanned aircraft 100 to rotate in the opposite direction from the direction of white arrows (counterclockwise) on water. This way the unmanned aircraft 100 can freely change directions when moving on water.

FIG. 5B illustrates how the unmanned aircraft 100 having four water wheels 12 changes directions. Rotating the water wheels 12C, 12D, 12E, and 12F each in the directions of black arrows causes the unmanned aircraft 100 to rotate in the direction of white arrows (clockwise) on water by the pressure of the pumped water. Reversing the respective rotating directions of the water wheels 12C, 12D, 12E, and 12F causes the unmanned aircraft 100 to rotate in the opposite direction from the direction of white arrows (counterclockwise) on water. This way the unmanned aircraft 100 can freely change directions when moving on water.

According to Embodiment 1, the unmanned aircraft 100 can move freely on land and on water by having an aquatic locomotion unit 7 and a terrestrial locomotion unit 5 (locomotion unit) respectively including water wheels (aquatic locomotion mechanism) 12 and wheels (terrestrial locomotion mechanism) 10, and water wheel connectors 8 and wheel connectors 6 (connector) respectively connecting the aquatic locomotion mechanism and terrestrial locomotion mechanism with the main body 1. Thus the present disclosure can realize an unmanned aircraft having terrestrial and aquatic locomotion capabilities independent of flight propellers.

Moreover, according to Embodiment 1, the terrestrial locomotion unit 5 and aquatic locomotion unit 7 (locomotion unit) are configured to allow the main body 1 of the unmanned aircraft 100 to change moving directions, and thus an unmanned aircraft capable of freely moving around, front to back and side to side on land and on water without depending on the flight propellers, can be realized.

### Embodiment 2

Next, a second embodiment of the present disclosure will be described. This embodiment differs from Embodiment 1 in that the water wheels 12 and water wheel shafts 13 of the aquatic locomotion unit (locomotion unit) 7 are replaced by a screw (aquatic locomotion mechanism) 15. Below, Embodiment 2 will be described, focusing on the differences from Embodiment 1. Parts having the same function and configuration as those of Embodiment 1 are given the same reference numerals.

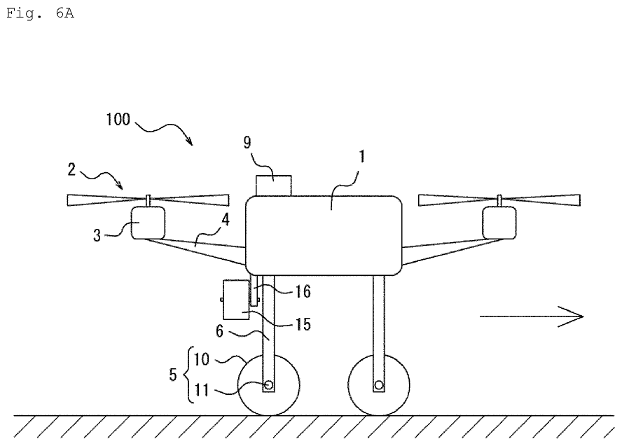

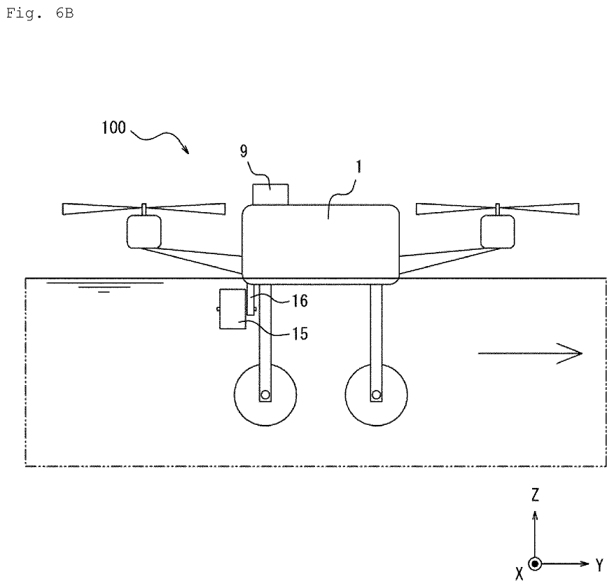

As illustrated in FIG. 6A, the terrestrial locomotion unit (locomotion unit) 5 of the unmanned aircraft 100 according to this embodiment includes wheels (terrestrial locomotion mechanism) 10 and wheel shafts 11. The unmanned aircraft 100 additionally includes a screw connector (connector) 16. The wheels 10 and wheel shafts 11 have the same function and configuration as those of Embodiment 1.

Referring to FIG. 6B, the aquatic locomotion unit 7 includes a screw (aquatic locomotion mechanism) 15. The screw connector 16 is a rod-like or plate-like member. The screw connector 16 extends downward from a bottom surface of the main body 1 of the unmanned aircraft 100 at one end, and is connected to the screw 15 at the other end. The screw 15 is a tubular member equipped with a propeller 27 that gives propelling force in the water to enable the unmanned aircraft 100 to move on water.

In this embodiment, one screw 15 is connected to one screw connector 16. The unmanned aircraft 100 may include a total of one screw 15. For clear view, FIG. 6A shows one screw 15. The number of screw 15 may be two or more as long as the screws allow the unmanned aircraft 100 to move on water while supporting the main body 1 on water via the screw connectors 16. The screw 15 is provided at a higher position than the wheels 10. The screw 15 is positioned such as to be fully submerged in water when the unmanned aircraft 100 moves on water. The screw 15 may be provided with an actuator (not shown) and may be driven based on a control signal from the control unit.

As illustrated in FIG. 6B, the propeller 27 of the screw 15 rotating in the water moves (forward) the unmanned aircraft 100 in the direction of the arrow (moving direction).

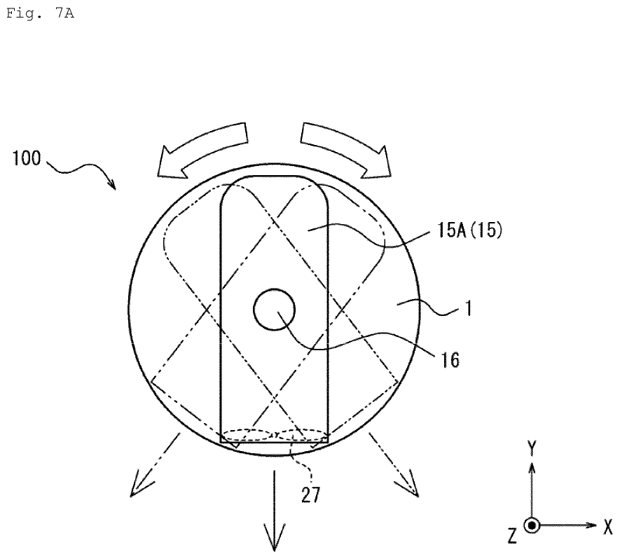

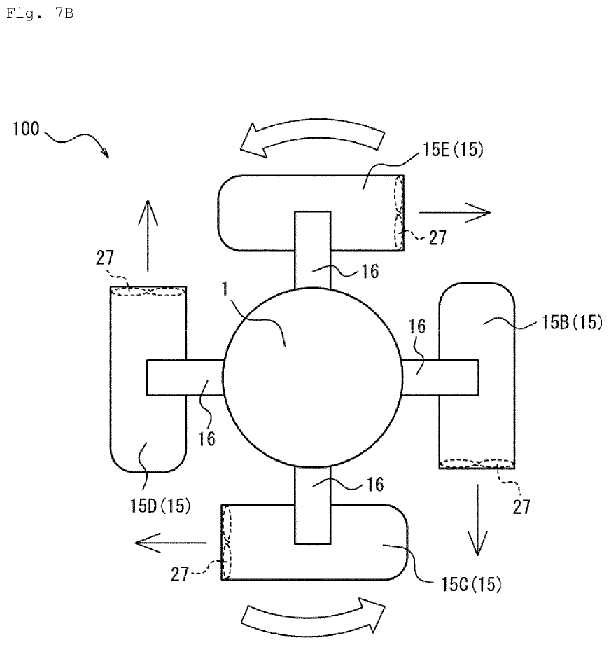

The aquatic locomotion unit 7 according to this embodiment may be configured to be able to change directions. FIG. 7A is a bottom view from below of the unmanned aircraft 100 having one screw 15A. The screw connector 16 is connected via a bearing (not shown) such as to allow pivoting in the directions of white arrows. This allows the screw connector 16 and the screw 15A to turn. The screw 15A may be turned by an actuator (not shown) provided to the screw connector 16 based on a control signal from the control unit. Water is pumped out in the directions of straight arrows from the outlet of the turning screw 15A. This way the unmanned aircraft 100 can freely change directions when moving on water.

FIG. 7B illustrates how the unmanned aircraft 100 having four screws 15 changes directions. The screws 15B, 15C, 15D, and 15E are each oriented in different direction and fixed. When driven, the water is pumped out from the outlet of each screw 15 in the directions of the black arrows, and the pressure of the pumped water causes the unmanned aircraft 100 to rotate in the direction of white arrows (counterclockwise) on water. Reversing the respective fixing orientations of the screws 15B, 15C, 15D, and 15E causes the unmanned aircraft 100 to rotate in the opposite direction from the direction of white arrows (clockwise) on water. This way the unmanned aircraft 100 can freely change directions when moving on water.

According to Embodiment 2, the unmanned aircraft 100 can move freely on land and on water by having the following similarly to Embodiment 1:

Aquatic locomotion unit 7 and a terrestrial locomotion unit 5 (locomotion unit) respectively including a screw (aquatic locomotion mechanism) 15 and wheels (terrestrial locomotion mechanism) 10; and

Screw connector 16 and wheel connectors 6 (connectors) respectively connecting the aquatic locomotion mechanism and terrestrial locomotion mechanism with the main body 1.

Thus the present disclosure can realize an unmanned aircraft having terrestrial and aquatic locomotion capabilities independent of flight propellers.

Moreover, according to Embodiment 2, the terrestrial locomotion unit 5 and aquatic locomotion unit (locomotion unit) 7 are configured to allow the main body 1 of the unmanned aircraft 100 to change moving directions, and thus an unmanned aircraft capable of freely moving around, front to back and side to side on land and on water without depending on the flight propellers, can be realized.

### Embodiment 3

Next, a third embodiment of the present disclosure will be described. This embodiment differs from Embodiment 1 in that the terrestrial locomotion unit (locomotion unit) 5 and aquatic locomotion unit (locomotion unit) 7 are configured with amphibious wheels 17, which are a combination of the wheel 10 and the water wheel 12. Below, Embodiment 3 will be described, focusing on the differences from Embodiment 1. Parts having the same function and configuration as those of Embodiment 1 are given the same reference numerals.

The amphibious wheels 17 function as wheels when the unmanned aircraft 100 moves on land, and function as water wheels when the unmanned aircraft moves on water. The functions and configurations as the wheel and water wheel are the same as the wheels 10 or water wheels 12 according to Embodiment 1 except for the features described below.

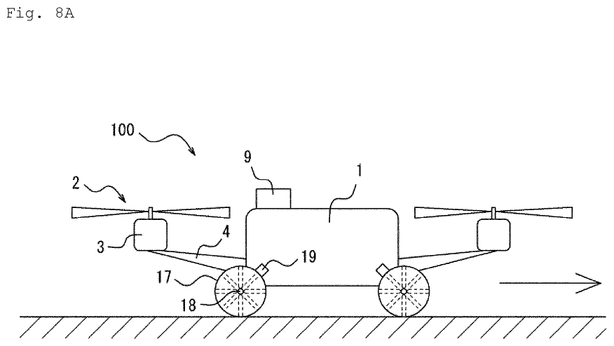

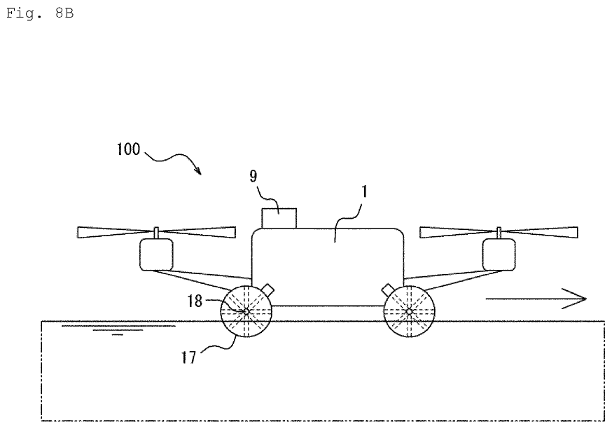

As illustrated in FIG. 8A and FIG. 8B, the unmanned aircraft 100 according to this embodiment includes amphibious wheels 17 and amphibious wheel shafts 18 as the terrestrial locomotion unit 5 and aquatic locomotion unit 7. The unmanned aircraft 100 additionally includes amphibious wheel connectors (connector) 19. The amphibious wheel connector 19 is a rod-like or plate-like member. The amphibious wheel connector 19 extends from a lower part of the main body 1 of the unmanned aircraft 100 at one end, and is connected to the amphibious wheel 17 via the amphibious wheel shaft 18 at the other end.

In this embodiment, one amphibious wheel 17 is connected to each one of the amphibious wheel connectors 19. The unmanned aircraft 100 may include a total of three amphibious wheels 17. For clear view, FIG. 8A and FIG. 8B show two amphibious wheels 17. The number of amphibious wheels 17 is not limited to three. As long as they allow the unmanned aircraft 100 to move while supporting the main body 1 on land and on water, there may be two or less, or four or more, amphibious wheels. The amphibious wheels 17 are positioned such as to be half submerged in water when the unmanned aircraft 100 moves on water. The amphibious wheel 17 may be provided with an actuator (not shown) and may be driven based on a control signal from the control unit.

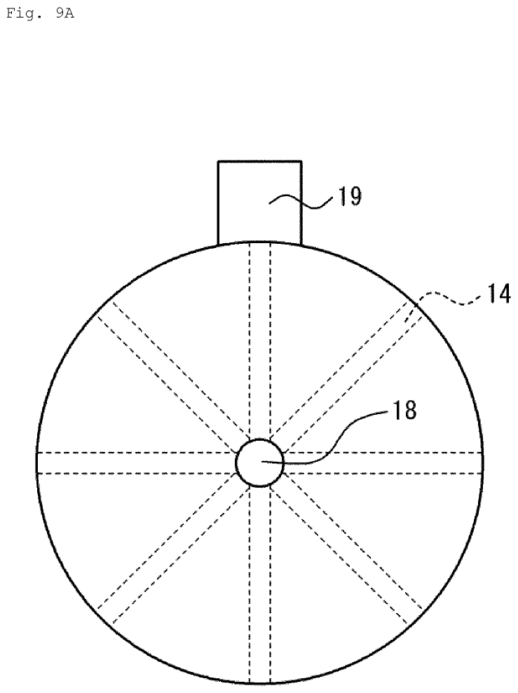

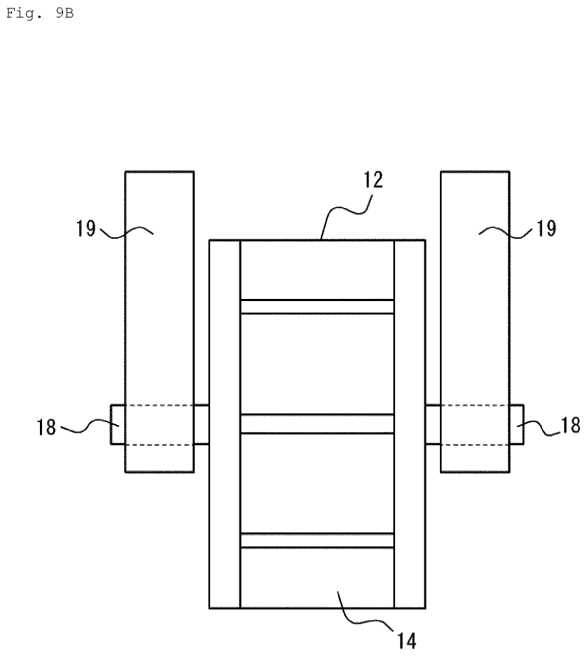

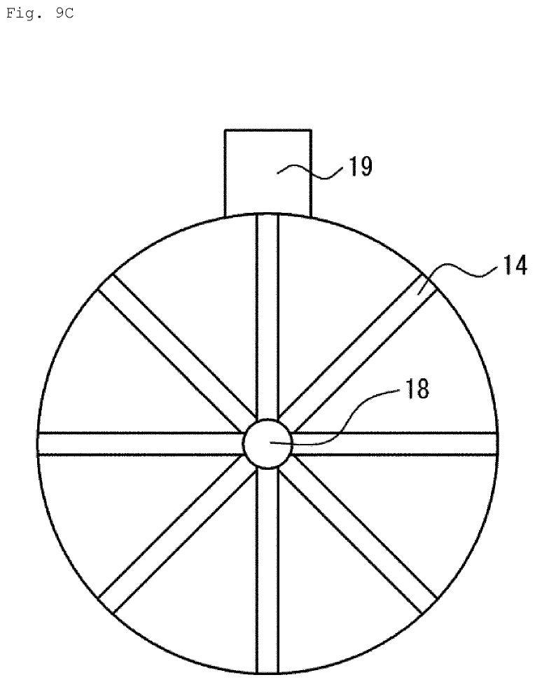

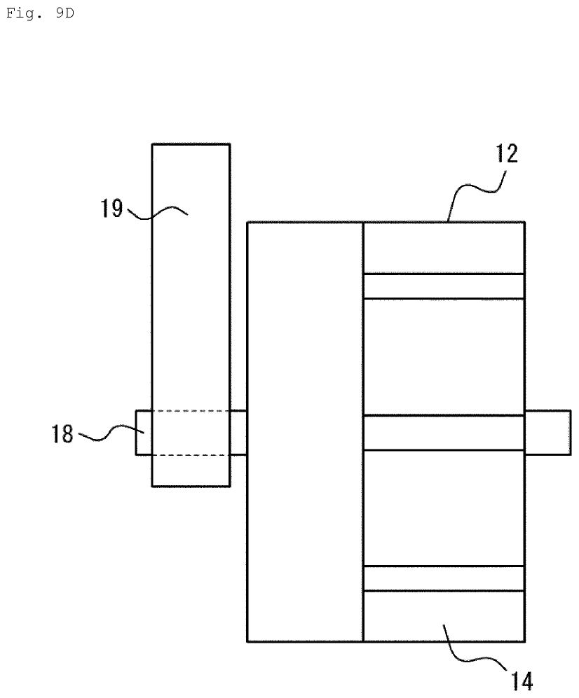

The amphibious wheel 17 may have a structure in which a wheel is fitted with a water wheel 12 inside, as illustrated in FIG. 9A and FIG. 9B. Specifically, a water wheel 12 with paddles 14 is sandwiched between discs of substantially the same size on both left and right sides in the horizontal direction, with the amphibious wheel shaft 18 passing through their center. The amphibious wheel shaft 18 is connected at both ends to the amphibious wheel connectors 19. Alternatively, the amphibious wheel 17 may have a structure in which a water wheel 12 is provided in parallel on the outer side of a wheel, as illustrated in FIG. 9C and FIG. 9D. Specifically, a water wheel 12 with paddles 14 is fitted with a wheel 10 of substantially the same size on the inner side, with the amphibious wheel shaft 18 passing through their center. The amphibious wheel shaft 18 is connected at both ends to the amphibious wheel connector 19.

The amphibious wheel 17 serving as both the terrestrial locomotion unit 5 and aquatic locomotion unit 7 may be configured to be able to change directions on land and on water. In the case where the unmanned aircraft 100 is fitted with three amphibious wheels 17, a direction change is possible if at least one of them is capable of changing directions. In the case where the unmanned aircraft 100 is fitted with four amphibious wheels 17, at least two of them may be designed capable of changing directions. A direction change on land may be done by turning a given number of amphibious wheel(s) 17 similarly to Embodiment 1. A direction change on water may be done by rotating a given number of amphibious wheel(s) 17 similarly to Embodiment 1. This way the unmanned aircraft 100 can freely change directions when moving on water and on land.

According to Embodiment 3, the unmanned aircraft 100 is equipped with amphibious wheels 17, which are a combination of a terrestrial locomotion mechanism and an aquatic locomotion mechanism, and which provide large propelling force as water wheels when the unmanned aircraft 100 moves on water and enable smooth movement when the unmanned aircraft moves on land. Thus the present disclosure can realize an unmanned aircraft having terrestrial and aquatic locomotion capabilities independent of flight propellers. Moreover, since no switching of the power source between terrestrial locomotion and aquatic locomotion is necessary, an erroneous motion caused by power switch operation is prevented. The amphibious wheel 17 that integrates two functions of a water wheel and a wheel can lower the superimposed load of the unmanned aircraft 100.

Moreover, according to Embodiment 3, similarly to Embodiment 1, the terrestrial locomotion unit 5 and aquatic locomotion unit (locomotion unit) 7 are configured to allow the main body 1 of the unmanned aircraft 100 to change moving directions, and thus an unmanned aircraft capable of freely moving around, front to back and side to side on land and on water without depending on the flight propellers, can be realized.

### Embodiment 4

Next, a fourth embodiment of the present disclosure will be described. This embodiment differs from Embodiment 1 in that the terrestrial locomotion unit (locomotion unit) 5 and aquatic locomotion unit (locomotion unit) 7 are configured with screw-cum-wheels 20, which are a combination of the wheel 10 and the screw 15. Below, Embodiment 4 will be described, focusing on the differences from Embodiment 1. Parts having the same function and configuration as those of Embodiment 1 are given the same reference numerals.

The screw-cum-wheels 20 function as wheels when the unmanned aircraft 100 moves on land, and function as screws when the unmanned aircraft moves on water. The functions and configurations as the wheel and screw are the same as the wheels 10 or screws 15 according to Embodiment 1 except for the features described below.

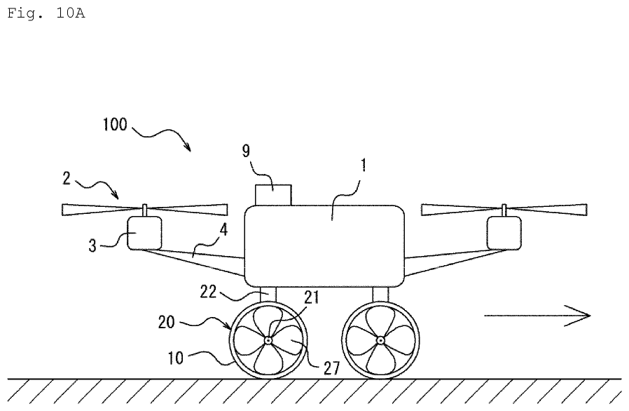

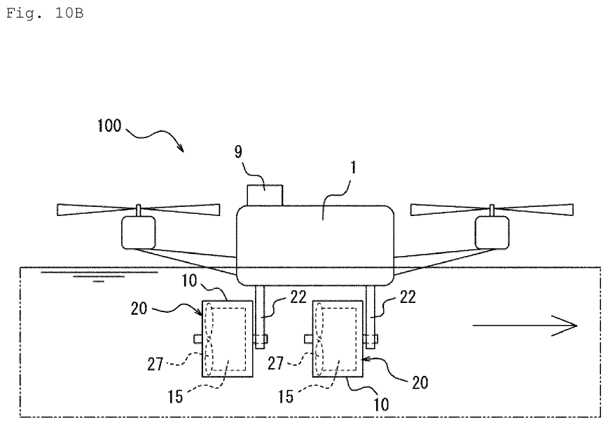

As illustrated in FIG. 10A and FIG. 10B, the unmanned aircraft 100 according to this embodiment includes screw-cum-wheels 20 and screw-cum-wheel shafts 21 as the terrestrial locomotion unit 5 and aquatic locomotion unit 7. The unmanned aircraft 100 additionally includes screw-cum-wheel connectors (connector) 22. The screw-cum-wheel connector 22 is a rod-like or plate-like member. The screw-cum-wheel connector 22 extends from a bottom surface of the main body 1 of the unmanned aircraft 100 at one end, and is connected to the screw-cum-wheel 20 via the screw-cum-wheel shaft 21 at the other end.

In this embodiment, one screw-cum-wheel 20 is connected to each one of the screw-cum-wheel connectors 22. The unmanned aircraft 100 may include a total of three screw-cum-wheels 20. For clear view, FIG. 10A and FIG. 10B show two screw-cum-wheels 20. The number of screw-cum-wheels 20 is not limited to three. As long as they allow the unmanned aircraft 100 to move while supporting the main body 1 on land and on water, there may be two or less, or four or more, screw-cum-wheels. The screw-cum-wheels 20 are positioned such as to be fully submerged in water when the unmanned aircraft 100 moves on water. The screw-cum-wheel 20 may be provided with an actuator (not shown) and may be driven based on a control signal from the control unit.

The screw-cum-wheel 20 may have a structure in which a screw 15 that can provide propelling force for aquatic locomotion is provided inside a wheel. Specifically, the screw 15 has a propeller 27 attached rotatably around the screw-cum-wheel shaft 21 as its axis, and a tubular outer part that functions as a wheel as it rotates. The screw-cum-wheel shaft 21 is connected at both ends to the screw-cum-wheel connector 22.

The unmanned aircraft 100 changes the direction of the screw-cum-wheels 20 and moves when moving on land or on water. When moving on land (when the screw-cum-wheels 20 function as a terrestrial locomotion mechanism), the unmanned aircraft 100 sets the direction of the screw-cum-wheels 20 such that the wheels 10 of the screw-cum-wheels 20 rotate in the direction of the arrow (moving direction) as illustrated in FIG. 10A. This causes the unmanned aircraft 100 to move in the direction of the arrow (moving direction), i.e., forward, on land as the screw-cum-wheels 20 are driven. When moving on water (when the screw-cum-wheels 20 function as an aquatic locomotion mechanism), the unmanned aircraft 100 sets the direction of the screw-cum-wheels 20 such that the propellers 27 of the screw-cum-wheels 20 pump out water in the opposite direction from the direction of the arrow (moving direction) as illustrated in FIG. 10B. This causes the unmanned aircraft 100 to move in the direction of the arrow (moving direction), i.e., forward, on water as the screw-cum-wheels 20 are driven.

The change of direction of the screw-cum-wheels 20 may be made possible by connecting the screw-cum-wheel connectors 22 via bearings (not shown) such that the screw-cum-wheels 20 are pivotable. The screw-cum-wheels 20 may be turned by actuators (not shown) provided to the screw-cum-wheel connectors 22 based on a control signal from the control unit.

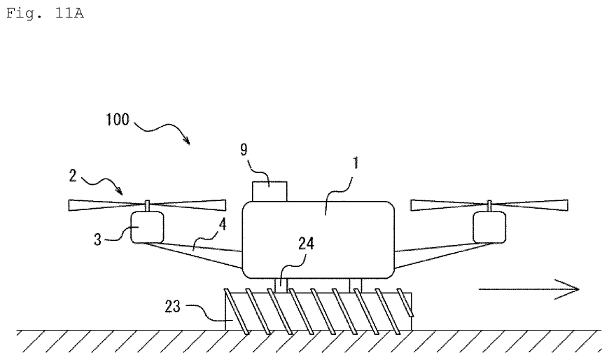

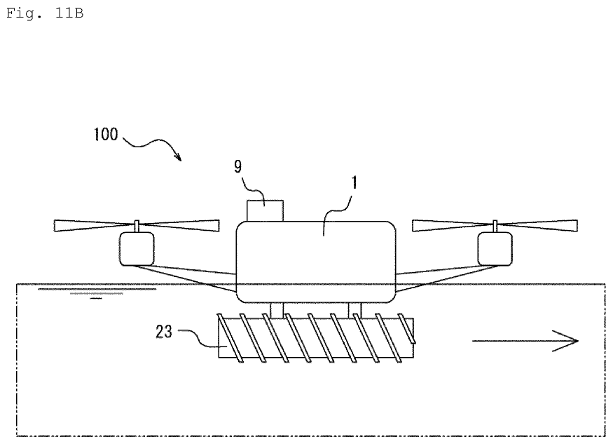

The screw-cum-wheel 20 may be an Archimedean screw 23 as illustrated in FIG. 11A and FIG. 11B. One Archimedean screw 23 is connected to a lower part of the main body 1 via an Archimedean screw connector (connector) 24 such as to longitudinally extend along the direction of the arrow (moving direction). The Archimedean screw 23 rotating in a first direction moves the unmanned aircraft 100 in the direction of the arrow (moving direction), and the Archimedean screw rotating in a second direction opposite from the first direction moves the unmanned aircraft 100 in the opposite direction from the direction of the arrow on land and on water.

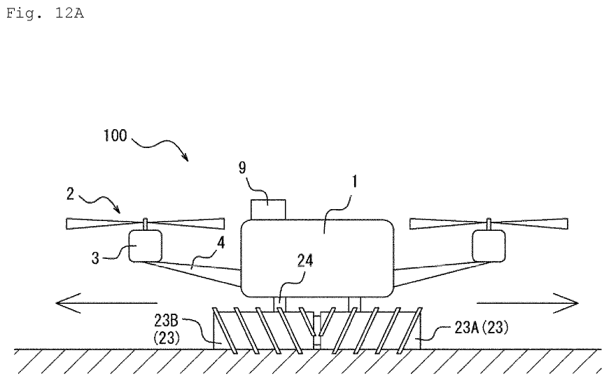

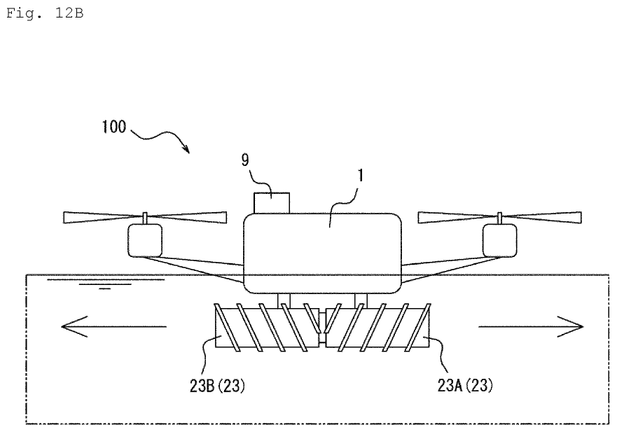

Two Archimedean screws 23 each having different spiral direction may be provided as illustrated in FIG. 12A and FIG. 12B. In FIG. 12A and FIG. 12B, an Archimedean screw 23A is provided on the right side, and an Archimedean screw 23B having a different spiral direction from that of Archimedean screw 23A is provided on the left side. The unmanned aircraft 100 moves on land and on water in either one of the directions of the arrows when one of the Archimedean screw 23A and Archimedean screw 23B is rotated.

The screw-cum-wheel 20 serving as both the terrestrial locomotion unit 5 and aquatic locomotion unit 7 may be configured to be able to change directions on land and on water. In the case where the unmanned aircraft 100 is fitted with three screw-cum-wheels 20, a direction change is possible if at least one of them is capable of changing directions. In the case where the unmanned aircraft 100 is fitted with four screw-cum-wheels 20, at least two of them may be designed capable of changing directions. In the case where the unmanned aircraft 100 is fitted with one Archimedean screw 23, the unmanned aircraft 100 can change moving directions by configuring the Archimedean screw connector 24 such as to be pivotable. In the case where the unmanned aircraft 100 is fitted with a plurality of Archimedean screws 23, the unmanned aircraft 100 can change moving directions by configuring the respective Archimedean screw connectors 24 of the Archimedean screws such as to be pivotable. A direction change on land may be done by turning a given number of screw-cum-wheel(s) 20 similarly to Embodiment 1. A direction change on water may be done by turning a given number of screw-cum-wheel connector(s) 22 similarly to Embodiment 2. Alternatively, a direction change on water may be done by driving screw-cum-wheels 20 that are oriented in different directions and fixed, similarly to Embodiment 2. This way the unmanned aircraft 100 can change moving directions when moving on water and on land.

According to Embodiment 4, the unmanned aircraft 100 is equipped with a screw-cum-wheel 20 or an Archimedean screw 23, which is a combination of a terrestrial locomotion mechanism and an aquatic locomotion mechanism, and which provides large propelling force as a screw when the unmanned aircraft 100 moves on water, and enables smooth movement when the unmanned aircraft moves on land. Thus the present disclosure can realize an unmanned aircraft having terrestrial and aquatic locomotion capabilities independent of flight propellers. Moreover, since no switching of the power source between terrestrial locomotion and aquatic locomotion is necessary, an erroneous motion caused by power switch operation is prevented. The screw-cum-wheel 20 or Archimedean screw 23 that integrates two functions of a screw and a wheel can lower the superimposed load of the unmanned aircraft 100.

Moreover, according to Embodiment 4, the terrestrial locomotion unit 5 and aquatic locomotion unit 7 (locomotion unit) are configured to allow the main body 1 of the unmanned aircraft 100 to change moving directions, and thus an unmanned aircraft capable of freely moving around, front to back and side to side on land and on water without depending on the flight propellers, can be realized.

### Embodiment 5

Next, a fifth embodiment of the present disclosure will be described. This embodiment differs from Embodiment 1 in that the wheel connector 6 is configured using an extendable connector (connector) 25 that makes the distance in the height direction changeable. Below, Embodiment 5 will be described, focusing on the differences from Embodiment 1. Parts having the same function and configuration as those of Embodiment 1 are given the same reference numerals.

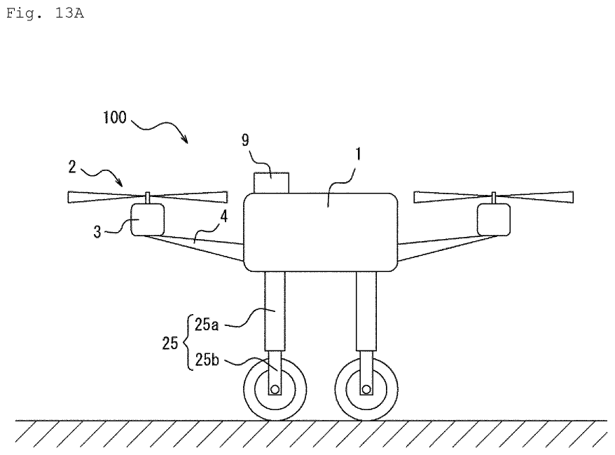

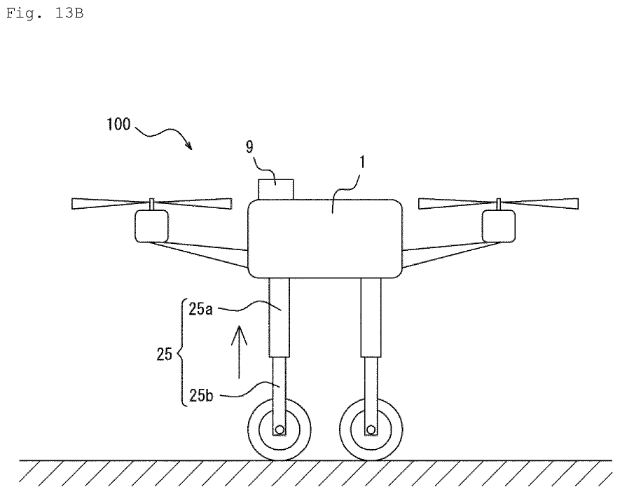

In this embodiment, as illustrated in FIG. 13A, extendable connectors 25 that can extend in the up and down direction are disposed on a bottom surface of the main body 1. The extendable connector 25 includes a main-body-side extendable connector 25a fixed to a bottom surface of the main body 1, and a locomotion-unit-side extendable connector 25b accommodated inside the main-body-side extendable connector 25a such as to be slidable in the axial direction. The locomotion-unit-side extendable connector 25b, as illustrated in FIG. 13B, extends outward from an outer end of the main-body-side extendable connector 25a and is kept to a state having a length along the longitudinal direction of the extendable connector 25. The extendable connector 25 is extendable to a position where at least part of the camera 9 disposed on the main body 1 of the unmanned aircraft 100 is not immersed in water. For example, the extendable connector 25 is extendable to a position where, when the unmanned aircraft 100 goes into water, with the wheels 10 touching the bottom of the water, the lens (not shown) on top of the camera 9 will not be submerged while the camera 9 is immersed from around the middle downward. Or, for example, the extendable connector 25 is extendable to a position where the entire camera 9 will not be submerged when the unmanned aircraft 100 goes into water, with the wheels 10 touching the bottom of the water. The extendable connector 25 may be driven by a hydraulic or electromagnetic actuator (not shown). In the following case this will prevent part of the unmanned aircraft 100 such as the camera 9 or control unit from being immersed in water, as the extendable connectors 25 extend to bring the locomotion mechanism down to the bottom of the water to support the unmanned aircraft 100 from below.

When, with the locomotion-unit-side extendable connectors 25b extended, the water is shallower than the height of the extendable connectors 25 from the bottom of the water.

Also, the camera 9 can come closer to a shooting target such as the ceiling surface of the upper slab 221 to take a picture of it.

According to Embodiment 5, the locomotion-unit-side extendable connectors 25b extend and allow the extendable connectors 25 to change the height in the up and down direction. Namely, the extendable connectors (connector) 25 can extend to a position where at least part of the camera disposed on the main body 1 of the unmanned aircraft 100 is not immersed in water. Thus an even more simply controllable unmanned aircraft having terrestrial and aquatic locomotion capabilities independent of flight propellers can be realized.

### Embodiment 6

Next, a sixth embodiment of the present disclosure will be described. This embodiment differs from Embodiment 1 in that the unmanned aircraft 100 includes a float 26 under the main body so that it will have buoyancy when landed on water, or has a locomotion unit having a lower specific weight than water. Below, Embodiment 6 will be described, focusing on the differences from Embodiment 1. Parts having the same function and configuration as those of Embodiment 1 are given the same reference numerals.

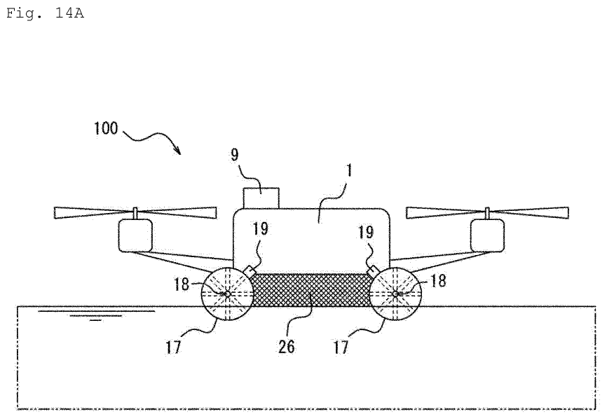

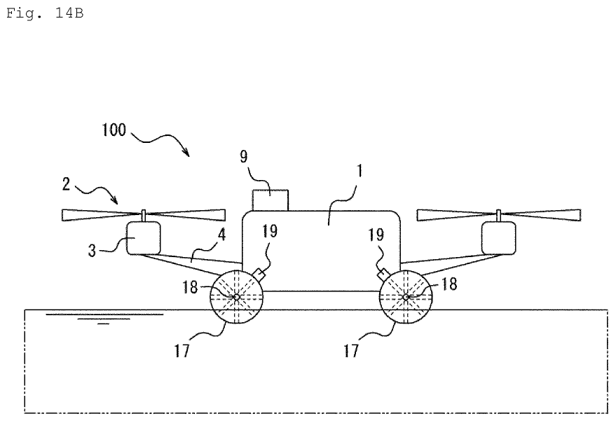

The unmanned aircraft 100 may be fitted with a float 26 below the main body 1 and on the inner side of the locomotion unit. The float 26 may be provided on the inner side of amphibious wheels 17, for example, as illustrated in FIG. 14A. The float 26 is set in contact with a bottom surface of the main body 1. The float 26 is made of a lightweight material having a lower specific weight than water. The float 26 may have a hollow structure that is partly or entirely hollow inside. The floating function of the float 26 ensures enough buoyancy to maintain at least part of the main body 1 of the unmanned aircraft 100 above water. For example, the float 26 ensures enough buoyancy to maintain the unmanned aircraft 100 in water in a state in which the main body 1 is immersed from around the middle downward while the upper half from around the middle upward of the main body 1 stays above water. Alternatively, the float 26 ensures enough buoyancy, for example, to maintain the unmanned aircraft 100 in water in a state in which the entire main body 1 stays above water. The buoyancy of the float 26 can also be used to create a half immersed state to secure the water wheel function of the amphibious wheels 17.

In this embodiment, the locomotion unit itself may have a lower specific weight than water. As illustrated in FIG. 14B, the amphibious wheels 17 and amphibious wheel shafts 18 (terrestrial locomotion unit and aquatic locomotion unit) provided below the main body, for example, may have a lower specific weight than water. The amphibious wheels 17 and amphibious wheel shafts 18 may have a hollow structure that is partly or entirely hollow inside. The floating function of the amphibious wheels 17 and amphibious wheel shafts 18 ensures enough buoyancy to maintain at least part of the main body 1 of the unmanned aircraft 100 above water. For example, the amphibious wheels 17 and amphibious wheel shafts 18 made of a lightweight material having a lower specific weight than water ensure enough buoyancy to maintain the unmanned aircraft 100 in water in a state in which the main body 1 is immersed from around the middle downward while the upper half from around the middle upward of the main body 1 stays above water. Alternatively, the amphibious wheels 17 and amphibious wheel shafts 18 ensure enough buoyancy, for example, to maintain the unmanned aircraft 100 in water in a state in which the entire main body 1 stays above water. The buoyancy of the amphibious wheels 17 and amphibious wheel shafts 18 can also be used to create a half immersed state to secure the water wheel function of the amphibious wheels 17.

According to Embodiment 6, either the unmanned aircraft further includes a float 26 that has the buoyancy for maintaining at least part of the main body 1 of the unmanned aircraft 100 above water, or, the amphibious wheels 17 and amphibious wheel shafts 18 (terrestrial locomotion unit and aquatic locomotion unit) have a lower specific weight than water. Thus a more easily controllable unmanned aircraft having terrestrial and aquatic locomotion capabilities independent of flight propellers can be realized.

While some embodiments have been described above as typical examples, it is clear for a person skilled in the art that many alterations and substitutions are possible without departing from the subject matter and scope of the present disclosure. Therefore the embodiments described above should not be interpreted as limiting and the present disclosure can be modified and altered in various ways without departing from the scope of the claims.

The unmanned aircraft 100 according to either Embodiment 1 or Embodiment 2 may include the extendable connector 25 according to Embodiment 5 instead of the wheel connector 6. The unmanned aircraft 100 according to Embodiment 3 may include the extendable connector 25 according to Embodiment 5 instead of the amphibious wheel connector 19. The unmanned aircraft 100 according to Embodiment 4 may include the extendable connector 25 according to Embodiment 5 instead of the screw-cum-wheel connector 22.

The main body 1 of the unmanned aircraft 100 according to one of Embodiment 1 to Embodiment 5 may further include the float 26 according to Embodiment 6.

The locomotion unit of the unmanned aircraft 100 according to one of Embodiment 1 to Embodiment 5 may be a locomotion unit having a lower specific weight than water as in Embodiment 6.

While the unmanned aircraft 100 in the embodiments is always equipped with both a terrestrial locomotion mechanism and an aquatic locomotion mechanism whether it moves on land or on water, the unmanned aircraft is not limited to this form. For example, one of the terrestrial locomotion mechanism and aquatic locomotion mechanism may be configured to allow itself to be accommodated inside the main body 1 for a size reduction of the unmanned aircraft 100.

While the embodiment shows a configuration in which the connectors can change height, the unmanned aircraft is not limited to this form. The unmanned aircraft 100 may be equipped with a configuration that allows its height in the up and down direction changeable, for example, by providing a telescopic mechanism to the main body 1 itself.

### REFERENCE SIGNS LIST

1 Main body
2 Flight propeller
3 Motor
4 Arm
5 Terrestrial locomotion unit (locomotion unit)
6 Wheel connector (connector)
7 Aquatic locomotion unit (locomotion unit)
8 Water wheel connector (connector)
9 Camera
10 Wheel (terrestrial locomotion mechanism)
11 Wheel shaft
12 Water wheel (aquatic locomotion mechanism)
13 Water wheel shaft
14 Paddle
15 Screw (aquatic locomotion mechanism)
16 Screw connector (connector)
17 Amphibious wheel (aquatic locomotion mechanism and terrestrial locomotion mechanism)
18 Amphibious wheel shaft
19 Amphibious wheel connector (connector)
20 Screw-cum-wheel (aquatic locomotion mechanism and terrestrial locomotion mechanism)
21 Screw-cum-wheel shaft
22 Screw-cum-wheel connector (connector)
23, 23A, 23B Archimedean screw (aquatic locomotion mechanism and terrestrial locomotion mechanism)
24 Archimedean screw connector (connector)
25 Extendable connector (connector)
25a Main-body-side extendable connector
25b Locomotion-unit-side extendable connector
26 Float
27 Propeller
110 Ground
200 Manhole
210 Neck
220 Structure body
230 Iron lid
240 Pipe
250 Duct
221 Upper slab
222 Lower slab
223 Side wall

1. An unmanned aircraft equipped with a flight propeller, comprising:
a main body;
a locomotion unit including an aquatic locomotion mechanism and a terrestrial locomotion mechanism independent of the flight propeller; and
a connector connecting the main body and a combination of the aquatic locomotion mechanism and the terrestrial locomotion mechanism.

2. The unmanned aircraft according to claim 1, wherein
the aquatic locomotion mechanism includes a water wheel positioned such as to be half submerged in water when the unmanned aircraft moves on water.

3. The unmanned aircraft according to claim 1, wherein
the aquatic locomotion mechanism includes a screw positioned such as to be fully submerged in water when the unmanned aircraft moves on water.

4. The unmanned aircraft according to claim 1, wherein
the terrestrial locomotion mechanism includes a wheel, and
the terrestrial locomotion mechanism and the aquatic locomotion mechanism are integrated.

5. The unmanned aircraft according to claim 1, wherein
the locomotion unit includes an Archimedean screw.

6. The unmanned aircraft according to claim 1, wherein
the locomotion unit is configured to allow the main body to change moving directions.

7. The unmanned aircraft according to claim 1, wherein
the connector is extendable to a position where at least part of a camera disposed on the main body is not submerged.

8. The unmanned aircraft according to claim 1, wherein
the unmanned aircraft additionally includes a float having buoyancy for maintaining at least part of the main body above water.

9. The unmanned aircraft according to claim 1, wherein
the locomotion unit has a lower specific weight than water.

10. The unmanned aircraft according to claim 2, wherein
the terrestrial locomotion mechanism includes a wheel, and
the terrestrial locomotion mechanism and the aquatic locomotion mechanism are integrated.

11. The unmanned aircraft according to claim 2, wherein
the locomotion unit is configured to allow the main body to change moving directions.

12. The unmanned aircraft according to claim 2, wherein
the connector is extendable to a position where at least part of a camera disposed on the main body is not submerged.

13. The unmanned aircraft according to claim 2, wherein
the unmanned aircraft additionally includes a float having buoyancy for maintaining at least part of the main body above water.

14. The unmanned aircraft according to claim 2, wherein
the locomotion unit has a lower specific weight than water.

15. The unmanned aircraft according to claim 3, wherein
the terrestrial locomotion mechanism includes a wheel, and
the terrestrial locomotion mechanism and the aquatic locomotion mechanism are integrated.

16. The unmanned aircraft according to claim 3, wherein
the locomotion unit is configured to allow the main body to change moving directions.

17. The unmanned aircraft according to claim 3, wherein
the connector is extendable to a position where at least part of a camera disposed on the main body is not submerged.

18. The unmanned aircraft according to claim 3, wherein
the unmanned aircraft additionally includes a float having buoyancy for maintaining at least part of the main body above water.

19. The unmanned aircraft according to claim 3, wherein
the locomotion unit has a lower specific weight than water.

20. The unmanned aircraft according to claim 4, wherein
the locomotion unit is configured to allow the main body to change moving directions.
